(19) United States
(12) Patent Application Publication
(10) Pub. No.: US 2007/0023223 A1
(43) Pub. Date: Feb. 1, 2007

(54) VEHICLE WITH COLLISION OBJECT PROTECTION DEVICE

(75) Inventors: Yutaka Okamoto, Wako-shi, Saitama (JP); Yuji Kikuchi, Wako-shi, Saitama (JP); Makoto Nagai, Wako-shi, Saitama (JP)

Correspondence Address: RANKIN, HILL, PORTER & CLARK LLP, 4080 ERIE STREET, WILLOUGHBY, OH, 44094-7836, US

(73) Assignee: HONDA MOTOR CO., LTD., Tokyo (JP)

(21) Appl. No.: 11/459,686

(22) Filed: Jul. 25, 2006

(30) Foreign Application Priority Data
Jul. 26, 2005 (JP) 2005-215224
Aug. 1, 2005 (JP) 2005-223215
Aug. 23, 2005 (JP) 2005-241246

(51) Int. Cl. B60R 21/34

(52) U.S. Cl. 180/274; 280/730.1

(57) ABSTRACT

A vehicle is provided with a collision object protection device. The collision object protection device inflates and expands an air bag on the vehicle when a collision to the vehicle is detected or predicted. The vehicle includes a front window glass formed by a laminated glass consisting of a couple of transparent base materials between which a transparent intermediate film is sandwiched. The air bag has a pair of pillar portions which inflate and expand along front pillars of the vehicle. The intermediate film in the front window glass has a noise insulation property.

### CROSS REFERENCE TO RELATED APPLICATIONS

This application claims the foreign priority benefit under Title 35, United States Code, §119(a)-(d) of Japanese Patent Applications No. 2005-241246 filed on Aug. 23, 2005, No. 2005-215224 filed on Jul. 26, 2005, and No. 2005-223215 filed on Aug. 1, 2005 in the Japan Patent Office, the disclosures of which are herein incorporated by reference in its entirety.

### BACKGROUND OF THE INVENTION

The present invention relates to a vehicle provided with a collision object protection device which absorbs an impact upon collision of a collision object, such as a pedestrian, with the vehicle, and thus protects the collision object.

For example, Japanese Laid-open Patent Application No. 2000-264146 (paragraph numbers 0015, 0019, and 0020 and FIG. 4) discloses a collision object protection device which inflates and expands an air bag on a vehicle if a collision with the vehicle is detected or predicted, so that an impact force applied to the collision object is absorbed and relieved. This collision object protection device includes an air bag formed by a tubular bag member bent at both ends to have a substantially U-shaped profile. The air bag consists of a main body portion which inflates and expands along the lower part of the front window glass of the vehicle, and a pair of pillar portions which inflates and expands from both ends of the main body portion along lower parts of the front pillars of the vehicle.

The air bag of this conventional collision object protection device is provided with a transparent scratch-protection film which expands to cover the front surface of the front window glass. Covering the front surface of the front window glass with the scratch-protection film makes it possible to absorb and relieve an impact force of the collision object to be hit by the front window glass as well as to prevent the collision object from penetrating through the front window glass.

However, the scratch-protection film is a part of the air bag in this conventional collision object protection device so that the scratch-protection film covering the front window glass will deflect when the air bag contracts after inflation and expansion.

In this instance, the driver has to look at the front through the deflected scratch-protection film which causes the front field of view to be distorted. Therefore, it becomes difficult for the driver to ensure the front field of view for driving the vehicle. In particular, if the scratch-protection film has an increased thickness or increased area to improve impact absorption characteristic, the front field of view is more distorted or the distorted area thereof extends further, which makes it more difficult for the driver to ensure his visibility.

In view of the above, it is an object of the present invention to provide a vehicle with a collision object protection device, which ensures better visibility of the driver as well as reliably absorbs and relieves an impact force applied to the collision object such as a pedestrian.

### SUMMARY OF THE INVENTION

According to a first aspect of the present invention, there is provided a vehicle provided with a collision object protection device which inflates and expands an air bag on the vehicle when a collision with the vehicle is detected or predicted. The vehicle includes a front window glass formed by a laminated glass comprising a couple of transparent base materials between which a transparent intermediate film is sandwiched. The air bag has a pair of pillar portions which inflate and expand along front pillars of the vehicle. The intermediate film in the front window glass has a noise insulation property.

The intermediate film may be a thin film which absorbs and relieves an impact force applied to an object (collision object) such as a pedestrian.

The air bag is provided with a pair of pillar portions which inflate and expand along front pillars of the vehicle, so the air bag also covers the front pillars, thereby preventing the collision object from directly colliding with the front pillars.

Further, the front window glass is formed by the laminated glass comprising a couple of transparent base materials between which a transparent intermediate film is sandwiched, so the intermediate film absorbs and relieves an impact force applied to the collision object.

When the collision object collides with the vehicle according to the present invention, the collision object collides with the pillar portion(s) of the air bag and thereafter moves on the front window glass. Therefore, the impact force applied to the collision object is reliably absorbed and relieved by the air bag and the front window glass.

Further, the intermediate film is sandwiched between the two transparent base materials, so the intermediate film does not contract even if the air bag contracts after inflation and expansion. Therefore, it is possible for the driver to ensure the front field of view after collision of the collision object, so that the driver enables to avoid a secondary accident.

Furthermore, the intermediate film has a noise insulation property, which makes it possible to decrease noise transmitted from the external to the interior of the vehicle, improving the sound insulation effect of the front window glass. Because the impact force absorption/relief property is improved with the use of the front window glass having improved sound insulation effect, it is possible to simplify the structure of the collision object protection device and to decrease the manufacturing cost of the collision object protection device.

According to a second aspect of the present invention, in the aforementioned vehicle, the air bag has a main body portion which inflates and expands along a lower part of the front window glass, and the pair of pillar portions which inflate and expand from both ends of the main body portion along the front pillars of the vehicle. A restriction may be provided at a boundary between the main body portion and each of the pillar portions such that transmission of a gas from the main body portion to the pillar portion is restricted until inflation and expansion of the main body portion is completed.

Descriptions such as “until inflation and expansion of the main body portion is completed” and “upon completion of the inflation and expansion of the main body portion” defined in the claims do not necessarily mean the exact time point at which the main body portion is completely inflated and expanded, and also include some sort of time difference.

In the conventional collision object protection device, it is necessary to compactly accommodate a large-sized air bag in terms of space requirement. For this reason, it is suggested that the pillar portions of the air bag are folded up where necessary and the both ends of the main body portion are folded back to the center so that the air bag is accommodated compactly below and at a center of the lower part of the front window glass.

However, according to this conventional collision object protection device, when the folded main body portion is supplied with air upon inflation and expansion of the air bag on the front window glass, the both ends of the main body portion flap to expand to the original fully-extended shape, during which air also enters into each pillar portion and thus the pillar portion inflates. If such a flapping motion of the air bag at both ends of the main body portion occurs simultaneously with the inflation and expansion of each pillar portion, the pillar portion expands before it contacts the vehicle body. This expanding pillar portion may flap further under the influence of the flapping motion of the main body, crosswind or the like, which makes it difficult to retain the pillar portion at a predetermined stable position.

In this collision object protection device according to the second aspect of the invention, when the collision object collides with the vehicle, the gas is transmitted to inflate and expand the air bag. In this event, the restriction restricts the transmission of the gas to the pillar portions during the inflation and expansion of the main body portion along the lower part of the front window glass. The pillar portions inflate and expand along the front pillars of the vehicle after the expansion of the main body portion is completed, avoiding the expansion of the pillar portion during the inflation and expansion of the main body portion.

According to a third aspect of the present invention, in the aforementioned vehicle, the air bag is a tubular bag member comprising a main body portion which inflates and expands along a lower part of the front window glass, and the pair of pillar portions which inflate and expand from both ends of the main body portion along the font pillars of the vehicle. Each pillar portion may have a vent hole at a distal end of the pillar portion, and a restriction for decreasing a sectional area of the bag member so as to restrict a flow of a gas directing to the vent hole. The restriction may be formed to be released by a pressure of the gas.

The conventional collision object protection device which inflates and expands the air bag on the front window glass and around the front pillars has a drawback in that there may be a time difference from when the collision object collides with the front side of the vehicle to when a secondary collision occurs between the collision object and the air bag. It is thus necessary in this collision object protection device to retain the internal pressure of the air bag for a considerably longer time than the air bag used for the occupant crash protection device arranged in the vehicle cabin.

Meanwhile, it is necessary to absorb the impact upon collision of the collision object with the air bag in order to prevent a secondary accident caused by the rebounding action of the collision object upon contact with the air bag. For this reason, the air bag may be provided with vent holes for discharging the gas from the air bag so that the internal pressure of the air bag is adjusted.

However, because a certain amount of gas is discharged through the vent holes, providing the vent holes arises another drawback in that if the collision object protection device should expand the air bag in a short period of time and thereafter retain the internal pressure of the air bag for a certain extended time, a large capacity is required for the inflator (gas generator) for generating a high pressure of gas. This results in a large installation space for and an increased weight of the increased-sized inflator, an increased manufacturing cost of the collision detection device, and the like.

In the collision object protection device according to the third aspect of the invention, each pillar portion has a vent hole at the distal end thereof so that the gas is discharged from the vent hole to adjust the internal pressure of the air bag. When the collision object collides with the air bag, the inflated and expanded air bag absorbs the impact force and protects the collision object from the secondary accident.

Further, providing the restriction for decreasing the sectional area of the bag member makes it possible to restrict the discharge amount of the gas as well as to rapidly inflate and expand the air bag due to the decreased volume of the air bag. In the meantime, the restriction is formed to be released by the pressure of the gas. This makes it possible to assure the impact absorption property upon contact with the air bag by ensuring the discharge of the gas through the vent hole as well as to retain the internal pressure of the air bag over an extended time period.

As described above, because the discharge of the gas is restricted upon expansion of the air bag to rapidly inflate and expand the air bag while the restriction is released by the pressure of the gas, it is possible to retain the internal pressure of the air bag over an extended time period without increasing the capacity of the inflator.

According to the foregoing collision object protection device, it is possible to ensure the space for installation of the inflator without any difficulty, and while avoiding weight increase of the inflator, to sufficiently absorb the impact upon collision of the collision object as well as to retain the internal pressure of the air bag over an extended time period.

Other features and advantages of the present invention will be apparent from the following detailed description with reference to the accompanying drawings.

### BRIEF DESCRIPTION OF THE DRAWINGS

The aspects of the present invention will become more apparent by describing in detail illustrative, non-limiting embodiment thereof with reference to the accompanying drawings, in which:

FIG. 1A is a top plan view of a vehicle according to the first embodiment of the present invention, in which an air bag is not inflated and expanded;

FIG. 1B is a top plan view of the vehicle shown in FIG. 1A, in which the air bag has been inflated and expanded;

FIG. 2A is a sectional view taken along the line A-A of FIG. 1A and illustrating a collision object protection device according to the first embodiment of the present invention;

FIG. 2B is an enlarged sectional view of the front window glass of the vehicle;

FIG. 3 is a side sectional view of the collision object protection device, illustrating a state in which the air bag has been inflated and expanded;

FIG. 4 is a sectional view taken along the line B-B of FIG. 1B;

FIGS. 5A and 5B show the test results according to the example of the first embodiment, of which FIG. 5A is a table showing HIC of the front pillar and HIC of the pillar portion of the air bag according to the first embodiment, and FIG. 5B is a table showing HIC of the conventional front window glass and HIC of the front window glass according to the present invention;

FIG. 6A is a top plan view of a vehicle according to the second embodiment of the present invention, in which an air bag is not inflated and expanded;

FIG. 6B is a top plan view of the vehicle shown in FIG. 6A, in which the air bag has been inflated and expanded;

FIG. 7 is an enlarged sectional view mainly illustrating details of one pillar portion of the air bag;

FIGS. 8A through 8E show a manner of folding the air bag, in which FIG. 8A explains a step for rolling up each pillar portion to make a roll, FIG. 8B explains a step for folding up the both ends of the main body portion in a bellows fashion, FIG. 8C explains a step for folding up an upper center of the main body portion in a bellows fashion, FIG. 8D explains a step for fixing a part where the upper center of the main body portion has been folded up into bellows by using tape, and FIG. 8E explains a step for moving the both ends of the main body portion toward the center;

FIG. 9A is a sectional view taken along the line C-C of FIG. 6A, illustrating the air bag not having been inflated and expanded;

FIG. 9B is a sectional view taken along the line D-D of FIG. 6B, illustrating the air bag having been inflated and expanded;

FIG. 10 is a plan view illustrating the movement of the main body portion until the inflation and expansion of the main body portion is completed, and FIG. 10 B is a plan view illustrating the movement of the pillar portions during the inflation and expansion of the pillar portions;

FIG. 11A is an enlarged sectional view illustrating a main part of a modified restriction:

FIG. 11B is a sectional view taken along the line E-E of FIG. 11A;

FIG. 11C is a sectional view illustrating a modification of the separation wall as shown in FIG. 11B;

FIG. 12A is a top plan view of a vehicle according to the third embodiment of the present invention, in which an air bag is not inflated and expanded;

FIG. 12B is a top plan view of the vehicle shown in FIG. 12A, in which the air bag has been inflated and expanded;

FIG. 13A is a sectional view taken along the line F-F of FIG. 12A, illustrating a collision object protection device according to the third embodiment of the present invention;

FIG. 13B is a sectional view taken along the line G-G of FIG. 12B;

FIG. 14 is an exploded perspective view illustrating the air bag of the collision object protection device;

FIGS. 15A through 15C illustrate an upper structure of one pillar portion of the collision object protection device, in which FIG. 15A is an enlarged plan view partly showing the upper part of the pillar portion, FIG. 15B is a sectional view taken along the line H-H of FIG. 15A, and FIG. 15C illustrates the process during which the air bag inflates and expands;

FIG. 16 is a graph showing the change of the internal pressure within the air bag of the collision object protection device according to the third embodiment of the present invention; and

FIGS. 17A through 17C are plan views partly illustrating modifications of the upper structure of one pillar portion according to the third embodiment of the present invention, in which FIG. 17A shows a first modification, FIG. 17B is a second modification, and FIG. 17C is a third modification.

### DESCRIPTION OF THE PREFERRED EMBODIMENTS

First Embodiment

First embodiment of the present invention will be described below with reference to the accompanying drawings.

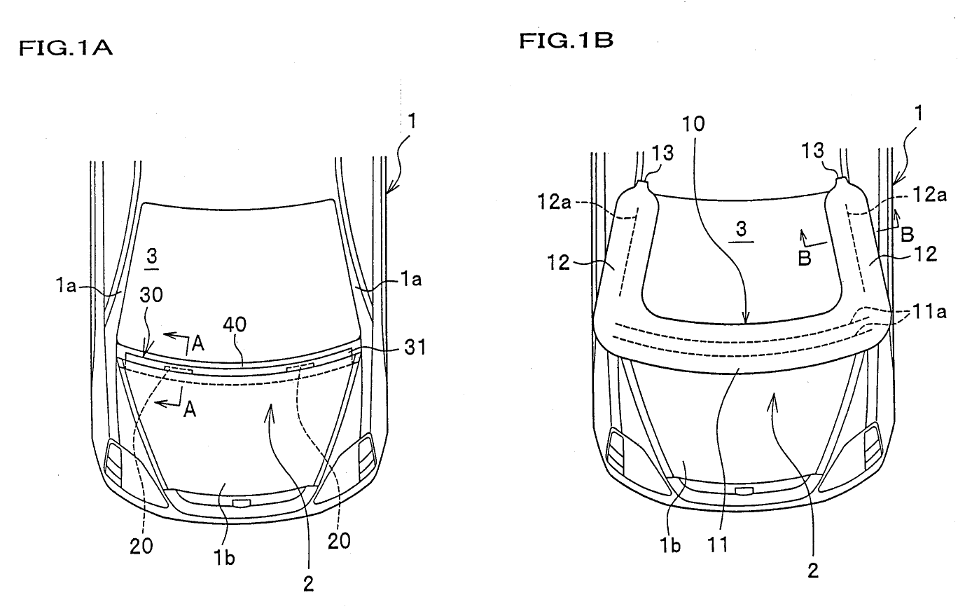

As shown in FIGS. 1A and 1B, a vehicle 1 according to this embodiment is an automobile. A collision object protection device 2 is mounted on a front part of the vehicle 1, so that when an object (collision object) such as a pedestrian collides with the vehicle 1 during the running of the vehicle 1 and then the collision object is involved in a secondary collision with it being hit by the upper surface of the front part of the vehicle 1, the collision object protection device 2 absorbs and relieves the impact force applied to the collision object.

The collision object protection device 2 as shown in FIGS. 1A and 1B includes a collision detection device (not shown) which detects or predicts a collision of a collision object such as a pedestrian with the vehicle 1, and an air bag 10 which is inflated and expanded on the vehicle 1 when the collision detection device detects or predicts the collision with the vehicle 1.

The collision detection device includes an ECU (Electronic Control Unit) which detects or predicts a collision of the collision object with the vehicle 1 based on a signal from a sensor (not shown) or radar (not shown) mounted on the vehicle 2. The collision detection device operates two inflators 20, 20 so as to generate gas and to inflate and expand the air bag 10 when it detects or predicts a collision with the vehicle 1. The collision detection device is configured using a known device, and the configuration thereof is not limited to a specific one.

Each inflator (gas generator) 20 detonates an explosive based on the collision detection signal or collision prediction signal from the collision detection device so that a large amount of gas is instantly supplied to the air bag 10.

As shown in FIG. 1B, the air bag 10 is a bag member having a tubular cross section. The air bag 10 includes a main body portion 11 which inflates and expands along a lower part of the front window glass 3 of the vehicle 1, and a pair of pillar portions 12, 12 which are bent at and extend from both ends of the main body portion 11 and which inflate and expand along the front pillars la, 1a (see FIG. 1A) of the vehicle 1.

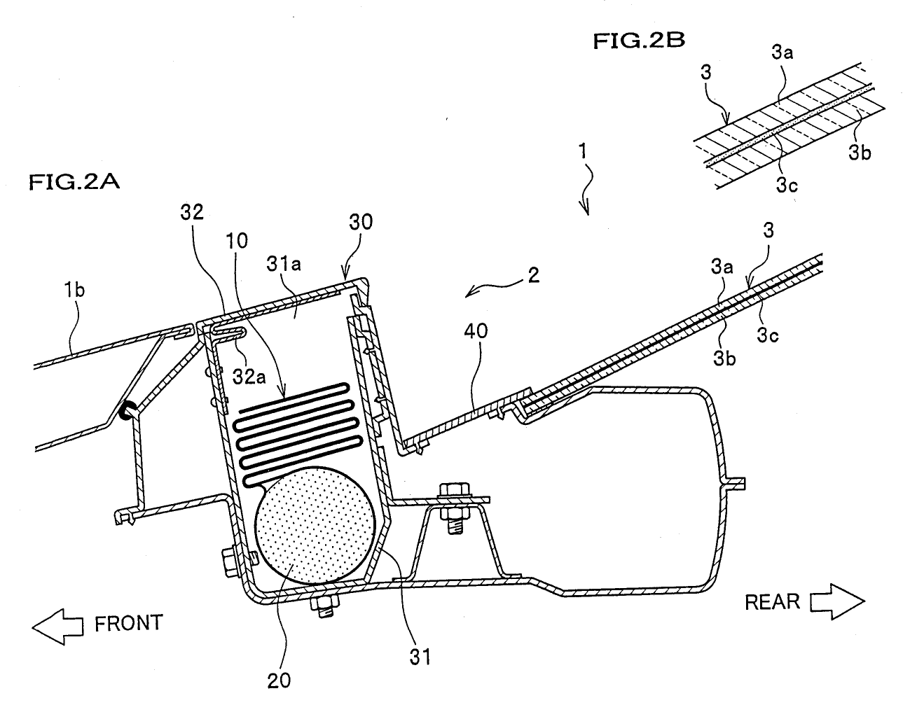

As seen in FIG. 2A, an air bag module 30 is provided between a hood 1b and the front window glass 3 of the vehicle 1. The air bag 10 is folded and accommodated, before inflation and expansion, in a retainer 31 of the air bag module 30.

The air bag module 30 extends in the width direction of the vehicle 1 along the rear end portion of the hood 1b, and includes a retainer 31 in the form of a box-like container accommodating the air bag 10 and the inflators 20, 20. A cowl top 40 in the form of a horizontal plate is arranged behind and at both sides of the retainer 31 so that the space between the hood 1b and the front window glass 3 is covered by the cowl top 40.

The retainer 31 has an upper opening 31a. The upper opening 31a is closed by a lid 32 as a lid member, so that the inside of the retainer 31 is sealed.

The inflators 20, 20 are accommodate at the bottom of the retainer 31, and the air bag 10 is folded and positioned above the inflators 20, 20.

As shown in FIG. 1A, two inflators 20, 20 are positioned in the retainer 31 according to this embodiment.

A hinge member 32a in the shape of an L-shaped plate member is attached to the lid 32 at one end thereof, and the other end of the hinge member 32a is attached to a front inner surface of the retainer 31. The mid portion of the hinge member 32a is folded and allowed to extend toward the outside of the vehicle 1.

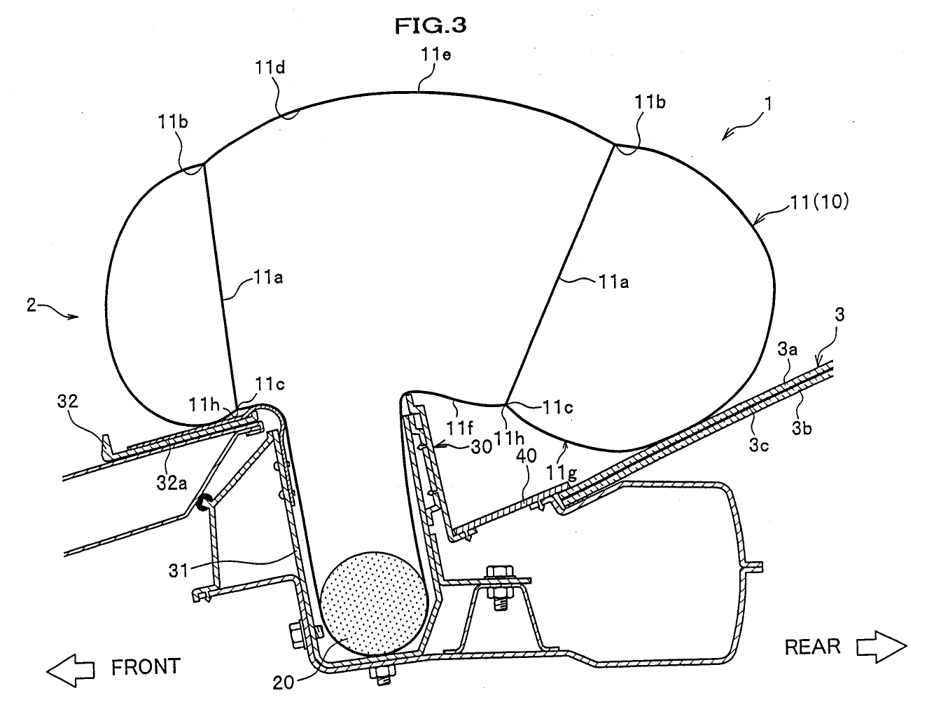

When the air bag 10 inflates and expands as illustrated in FIG. 3, the expansive force of the air bag 10 opens the lid 32 toward the outside of the vehicle. The hinge member 32a then extends in accordance with the displacement of the lid 32, allowing the lid 32 to be opened toward the front side of the vehicle 1.

As shown in FIG. 1B and FIG. 3, the main body portion 11 of the air bag 10 is a bag member having a tubular cross section which inflates and expands in the width direction of the vehicle 1 along a lower outside part of the front window glass 3. Extending longitudinally of the interior of this bag member are two tethers 11a, 11a. Each of the tethers 11a, 11a is a separation wall arranged substantially in the vertical direction. The upper edge 11b and the lower edge 11c of the tether 11a are connected to the inner surface 11d of the main body portion 11, so that the upper surface 11e (remote from the front window glass 3) of the main body portion 11 and the lower surface 11f (adjacent to the front window glass 3) are connected through the tether 11a.

Because the tethers 11a, 11a connect the upper surface 11e and the lower surface 11f of the main body portion 11, the outer surface of the main body portion 11 is pulled back by the connecting portions between the tethers 11a, 11a and the inner surface 11d upon inflation and expansion of the main body portion 11.

Therefore, dent portions 11h, 11h are formed and extend linearly on an area 11g of the main body portion 11 riding on the vehicle 1. Because the dent portions 11h, 11h are formed along the longitudinal direction of the main body portion 11, the axial section of the main body portion 11, after inflation and expansion, becomes wider, which makes the lower surface of the main body portion 11 more flattened and thus makes the area 11g where the main body portion 11 rides on the vehicle 1 to be wider.

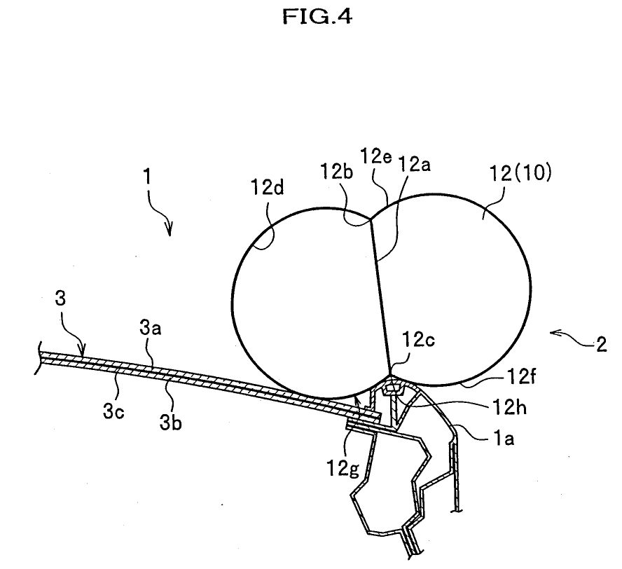

As shown in FIGS. 1A, 1B, and 4, each pillar portion 12 of the air bag 10 is a bag member having a tubular cross section which inflates and expands in the vertical direction along the front pillars 12, 12 of the vehicle 1. Because two pillar portions 12, 12 are the same in construction, only one pillar portion 12 positioned on the right hand side as viewed from the front side of the vehicle 1 will be described in the following description, and description to the left-side pillar portion 12 will be omitted.

Extending longitudinally of the interior of this pillar portion 12 is a tether 12a (anchoring member defined in the claims). The tether 12a is a separation wall arranged substantially in the vertical direction against the front window glass 3. The upper edge 12b and the lower edge 12c of the tether 12a are connected to the inner surface 12d of the pillar portion 12, so that the upper surface 12e (remote from the front pillar 1a) of the pillar portion 12 and the lower surface 12f (adjacent to the front pillar la) are connected by the tether 12a.

As with the main body portion 11 of the air bag 10, because the tether 12a connects the upper surface 12e and the lower surface 12f of the pillar portion 12, the outer surface of the pillar portion 12 is pulled back by the connecting portions between the upper edge 12b and the lower edge 12c of the tether 12a and the inner surface 12d of the pillar portion 12 upon inflation and expansion of the pillar portion 12.

Therefore, a dent portion 12h is formed and extends linearly on an area 12g of the pillar portion 12 riding on the vehicle 1. Because the dent portion 12h is formed along the longitudinal direction of the pillar portion 12, the axial section of the pillar portion 12, after inflation and expansion, becomes wider, which makes the lower surface of the pillar portion 12 more flattened and thus makes the area 12g where the pillar portion 12 rides on the vehicle 1 to be wider. The dent portion 12h is formed in such a position as to allow the upper surface of the front pillar 1a to enter the dent portion 12h.

A vent hole 13 is formed at a distal end of the pillar portion 12. The vent hole 13 is provided to adjust the internal pressure within the expanded air bag 10 by discharging the air from the air bag 10, in order to prevent a rebounding action of the collision object upon collision with the air bag 10.

Next, with reference to FIG. 2B, the front window glass 3 of the vehicle 1 will be described. The front window glass 3 is formed by a laminated glass including two transparent base materials 3a, 3b made of glass and superposed one on top of another with a transparent intermediate film 3c being sandwiched therebetween.

The intermediate film 3c is a thin film having a noise insulation property. The intermediate film 3c decreases noise transmitted from the external to the interior of the vehicle 1.

The intermediate film 3c also has toughness so as to absorb an impact of the collision object hit by the front window glass 3 without allowing the collision object to penetrate through the front window glass 3.

According to this embodiment, by providing the intermediate film 3c in the front window glass 3, the front window glass 3 absorbs an impact more than the air bag 10 does. In other words, more impact can be absorbed at the front window glass 3 rather than at the air bag 10. Therefore, the impact absorption property is more improved at the front window glass 3 than at the air bag 10.

The intermediate film 3c may be made of any known materials. However, PVB (Polyvinyl Butyral) may be used. Preferably, the ratio of load to elongation (load/elongation) of the intermediate film 3c is in the range of 0.4-0.7 N/mm.

According to the vehicle 1 with the collision object protection device 2 as constructed above, the following advantages are achieved.

When the collision detection device (not shown) detects or predicts a collision with the vehicle 1 based on a signal from the sensor (not shown) or the radar (not shown) mounted on the vehicle 1, the collision detection device operates the inflators 20, 20. The inflators 20, 20 then generate gas to inflate and expand the air bag 10 on the vehicle 1 as shown in FIG. 1B.

According to the vehicle 1 of this preferred embodiment, the air bag 10 has the pair of pillar portions 12, 12 which inflate and expand along the font pillars 1a, 1a of the vehicle 1, and so the front pillars 1a, 1a are covered by the air bag 10, thereby preventing the collision object from directly colliding with the front pillars 1a, 1a.

According to this embodiment, because dent portions 11h, 12h are formed on the area 11g, 12g where the main body portion 11 and the pillar portions 12 of the expanded air bag 10 ride on the vehicle 1 as illustrated in FIGS. 3 and 4, the axial sections of the main body portion 11 and the pillar portions 12 become wider, which makes it possible to widen the areas 11g, 12g.

Further, because the upper surface of the front pillar la is allowed to enter the dent portion 12h of each pillar portion 12, the pillar portions 12, 12 are engaged with the front pillars 1a while ensuring a sufficient contact area between the pillar portions 12, 12 and the vehicle 1. This advantageously prevents the pillar portions 12, 12 from moving off from predetermined positions on the front pillars 1a, 1a due to rolling or swaying upon inflation and expansion of the air bag 10, wind pressure exerted on the inflated and expanded air bag 10, and a pressing force from the collision object. Therefore, it is possible to keep the state in which the air bag 10 covers the front pillars 1a, 1a of the vehicle 1.

Further, because moving off (deviation) of the pillar portions 12, 12 of the air bag 10 on the front pillars 1a, 1a is prevented, it is possible to securely move the collision object hit by the pillar portion 12 along the pillar portion 12 to the upper surface of the front window glass 3.

Further, the front window glass 3 is formed by the two transparent base materials 3a, 3b sandwiching therebetween the transparent intermediate film 3c as illustrated in FIG. 2B, so that the impact force upon collision is absorbed and relieved by the intermediate film 3c. Therefore, the front window glass 3 absorbs more impact than the air bag 10 does. Because the front window glass 3 has more improved impact absorption property than the air bag 10, when the collision object that has collided with the air bag 10 moves toward the upper surface of the front window glass 3, an impact force applied to the collision object is reliably absorbed and relieved.

Further, because the intermediate film 3c has toughness so as to absorb the impact of the collision object without allowing the collision object to penetrate through the front window glass 3, it is possible to prevent the collision object from penetrating through the front window glass 3.

Further, because the intermediate film 3c is sandwiched between the two transparent base materials 3a, 3b, the intermediate film 3c does not deflect even if the air bag 10 contracts after inflation and expansion. Therefore, it is possible for the driver to ensure the front field of view after collision of the collision object, so that the driver enables to avoid a secondary accident after the collision.

Furthermore, the intermediate film 3c has a noise insulation property to improve the sound insulation effect of the front window glass 3. Because the impact force absorption/relief property is improved with the use of the front window glass 3 having improved sound insulation effect, it is possible to simplify the structure of the collision object protection device 2 and to decrease the manufacturing cost of the collision object protection device 2.

While the present invention has been described with reference to the first embodiment, the present invention is not limited to this specific embodiment. According to this embodiment, as shown in FIG. 4, the tether 12a extending in each pillar portion 12 enables the dent portion 12h to be formed on the outer surface of the pillar portion 12, so that moving off (deviation) of the pillar portion 12 is prevented with the front pillar la entered the dent portion 12h. However, the construction of the anchoring member for each pillar portion 12 is not limited to this specific embodiment.

For example, a strap or sewn part may be provided at outer surface of the pillar portion 12 so that even if the pillar portion 12 tilts inward in the width direction of the vehicle 1, a tension is caused at the outer surface of the pillar portion 12 so as to pull back the pillar portion 12 outward in the width direction of the vehicle 1. Therefore, it is possible to stabilize or anchor the pillar portion 12 on the upper surface of the front pillar 1a.

### EXAMPLE

Description will be given to an example for proving advantages of the present invention. In this example, results of an impact test, using the vehicle 1 according to the first embodiment, are shown.

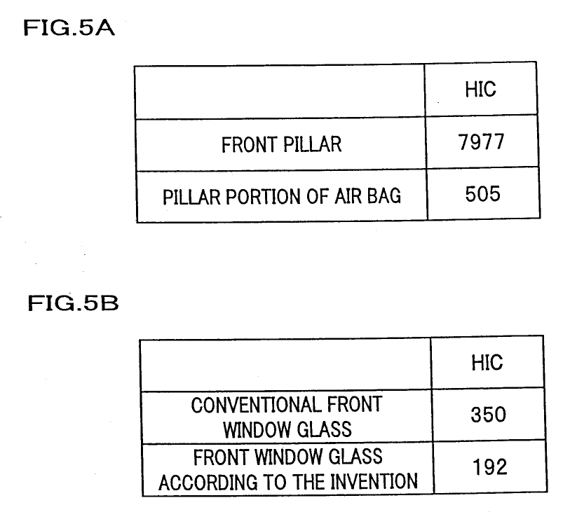

FIGS. 5A and 5B show the test results according to this example, of which FIG. 5A is a table showing HIC of the front pillar and HIC of the pillar portion of the air bag according to the first embodiment, and FIG. 5B is a table showing HIC of the conventional front window glass and HIC of the front window glass according to the present invention.

In this example, the intermediate film for the front window glass according to the present invention is provided as available from Sekisui Chemical Co., Ltd. under the product name S-LEC Acoustic Film. The intermediate film has 0.76 mm thickness, and each of the transparent base materials has 2 mm thickness.

The conventional front window glass has the same thickness as the front window glass according to the present invention.

In the impact tests, HICs (Head Injury Criterion) of the front window glass and the front pillar are determined when an impactor in the form of a sphere having 4.8 kg weight and 165 mm diameter collides with the vehicle at a speed of 40 km/h.

As shown in the table of FIG. 5A, the impact test results indicate that the HIC of the front pillar is 7977, whereas the HIC of the pillar portion of the air bag according to the present invention is 505.

Further, as shown in the table of FIG. 5B, HIC of the conventional front window glass is 350, whereas HIC of the front window glass according to the present invention is 192.

This example indicates that the vehicle according to the present invention reliably absorbs and relieves an impact force applied to the collision object by the air bag and the front window glass.

Second Embodiment

Second embodiment of the preset invention will be described below with reference to the accompanying drawings. In the drawings, parts similar to those previously described with reference to the first embodiment are denoted by the same reference numerals, and detailed description thereof will be omitted.

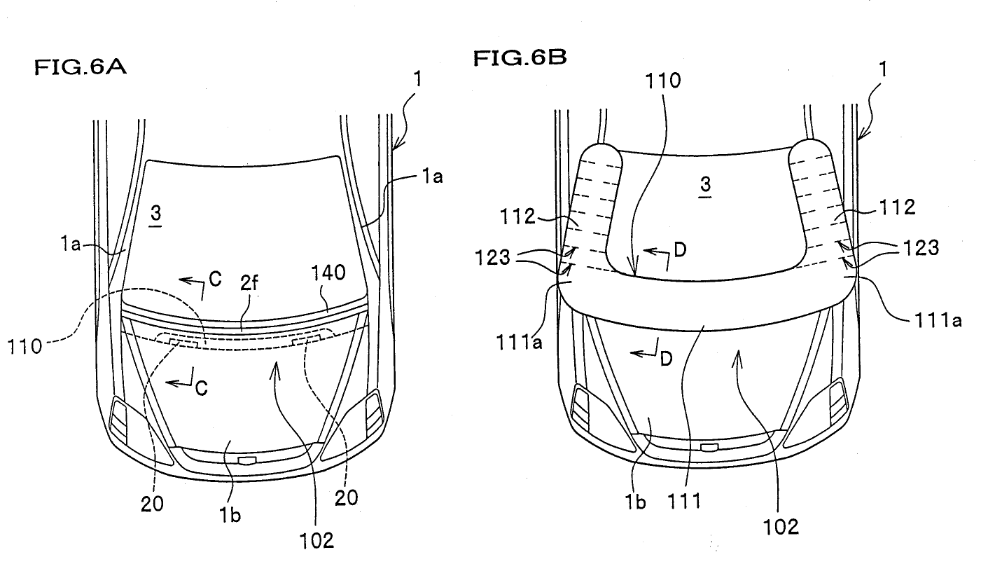

As shown in FIGS. 6A and 6B, a collision object protection device 102 has an air bag 110. The air bag 110 includes a main body portion 111 which inflates and expands along a lower part of the front window glass 3 of the vehicle 1, and a pair of pillar portions 112, 112 which inflate and expand from both ends 111a, 111a of the main body portion 111 along the front pillars 1a, 1a of the vehicle 1. Each pillar portion 112 is provided with sewn parts (restriction) 123 arranged at predetermined space intervals in the longitudinal direction of the pillar portion 112. For convenience of reference in the following description, having considered the state in which the air bag 110 has been inflated and expanded, the longitudinal direction of the main body portion 111 is referred to as a horizontal direction whereas the longitudinal (extension) direction of the pillar portions 112 is referred to as a vertical direction.

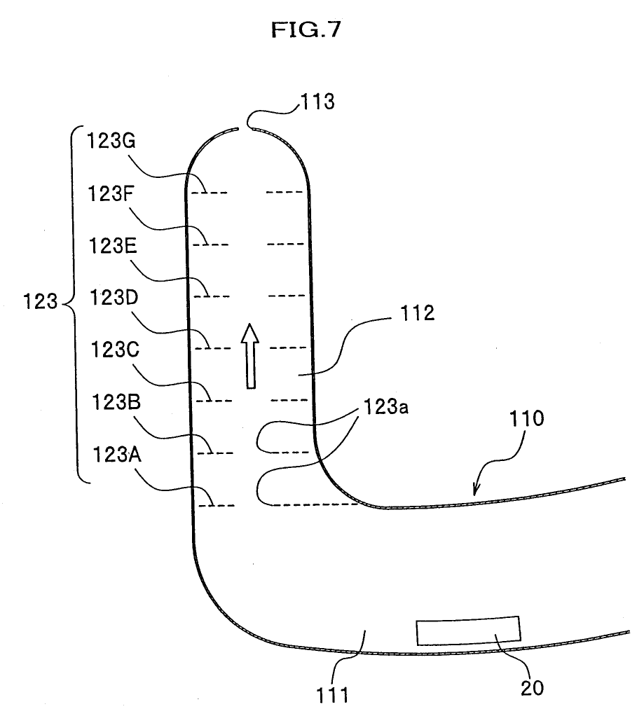

To be more precise, as shown in FIG. 7, the sewn part 123 consists of a first sewn part 123A formed by sewing a boundary between the main body portion 111 and each pillar portion 112 with a thread having a predetermined strength, and other second through seventh sewn parts 123B-123G which are formed in order in the vertical direction from the first sewn part 123A and with predetermined space intervals. Each of the sewn part 123A-123G has a non-sewn part (i.e., center part in this embodiment) where sewing is not applied partly. This non-sewn part functions as a gas flow passage (communication portion) 123a for communicating each of the spaces partitioned by the sewn parts 123A-123G.

By arbitrarily setting the strength of the thread, the seam pitch, the number of sewn parts and the like, each sewn part 123A-123G restricts the transmission of gas from the main body portion 111 to the pillar portions 112 until the inflation and expansion of the main body portion 111 is completed. Upon completion of the inflation and expansion of the main body portion 111, the expansive force exerted on both ends 111a, 111a of the main body portion 111 (i.e., tensile force caused by expansion of the main body portion 111 and pulling the sewn part 123) and the like breaks or cuts off the sewn part 123 in order from the lower first sewn part 123A. Cutting off the sewn parts 123A-123G is facilitated when the inflation and expansion of the main body portion 111 is completed and a certain pressure of the gas passes through the gas flow passage 123a while widening the gas flow passage 123a.

A vent hole 113 is formed in the distal part of each pillar portion 112 so as to absorb an impact energy upon collision of the collision object. The gas is discharged from the vent hole 113 upon collision of the collision object so that the impact applied to the collision object can be relieved. The vent hole 113 may be formed in the reverse side of the main body portion 111.

Description will be given to the manner of folding and accommodating the air bag 110.

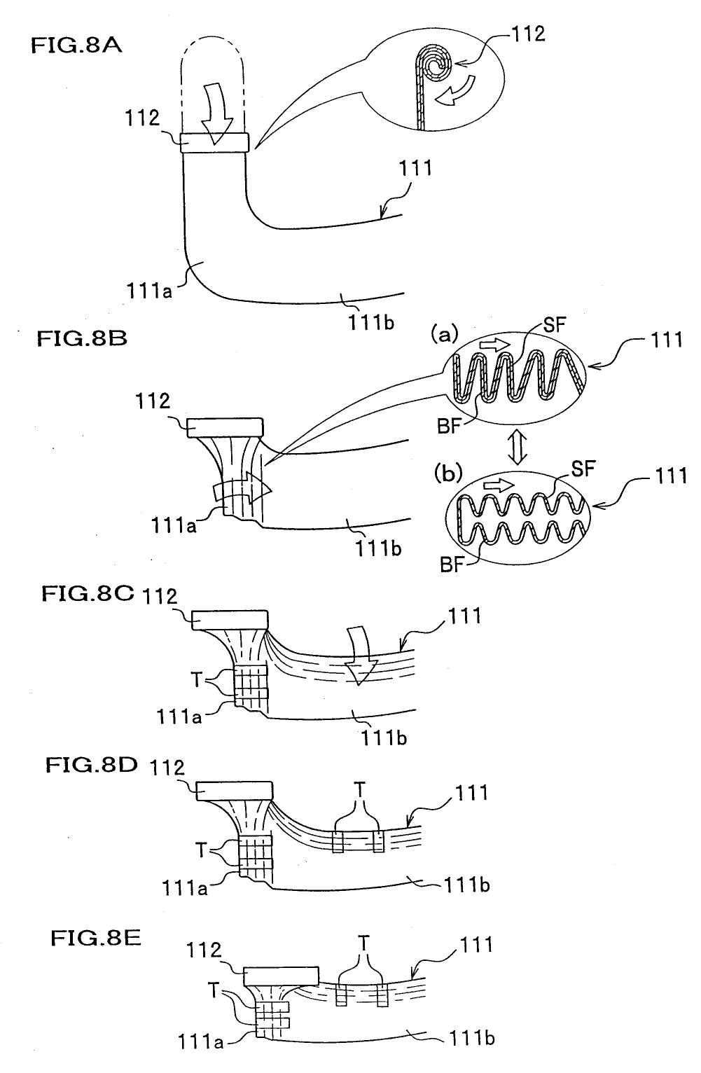

As shown in FIG. 8A, each pillar portion 112 is rolled up from the distal end thereof in a direction remote from the front window glass 3 and with the distal end as the center of the roll. Rolling up the pillar portion 112 in this manner makes it possible to expand the pillar portion 112 at a certain constant rate. Further, rolling up the pillar portion 112 in the direction remote from the front window glass 3 to make an involute roll makes it possible to expand the pillar portion 112 while pressing the pillar portion 112 against the vehicle body. This advantageously prevents the pillar portions 112, 112 from standing up or rising and further restricts a flow of the gas into the pillar portions 112, 112 during expansion of the main body portion 111. Next, as shown in FIG. 8B, the both ends 111a of the main body portion 111 (i.e., each part located within the width of the right and left ends of the pillar portion 112) are folded up in the horizontal direction in a bellows fashion. Thereafter, as shown in FIG. 8C, these folded-up parts in the shape of bellows are fixed by tape T that is easily cut.

“Folding up in a bellows fashion” indicates that the front surface SF and the reverse surface BF of the main body portion 111 are superposed each other and they are alternately folded back together into corrugated shape as illustrated in (a) of FIG. 8B as well as that the front surface SF and the reverse surface BF of the main body portion 111 are not superposed and each of these surfaces is separately and alternately folded back into corrugated shape as illustrated in (b) of FIG. 8B. Folding up in this manner makes it possible to quickly transmit the gas and also to expand the main body portion 111 linearly in one direction.

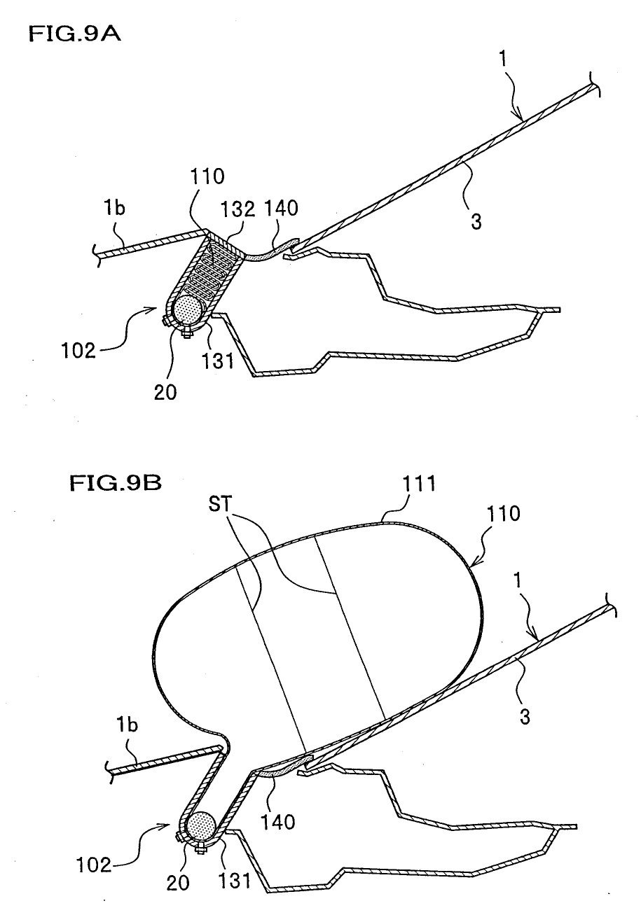

Next, as shown in FIG. 8C, the center part 111b (remaining part except the ends 111a, 111a) of the main body portion 111 is folded up in the vertical direction only at an upper part thereof in a bellows fashion. This folded up part is fixed by tape T that is easily cut as illustrated in FIG. 8D. Finally, as shown in FIG. 8E, the both ends 111a, 111a of the main body portion 111 are folded and moved to the center. As seen in FIG. 6A, the air bag 110 is thus positioned around the center and accommodated below the cowl top 140 which is arranged below the front window glass 3. To be more specific, as shown in FIG. 9A, the air bag 110 is accommodated in the retainer 131 which is arranged below the rear end of the hood 1c. The retainer 131 has an upper opening so that after the air bag 110 is accommodated in the retainer 131 the opening is closed by the lid member 132. The lid member 132 forms a continuous surface with the cowl top 140.

Operation of the collision object protection device 102 will be described.

As shown in FIGS. 9A and 9B, when the collision object protection device 102 detects or predicts a collision of a collision object such as a pedestrian with the vehicle 1, the collision object protection device 102 operates the inflators 20, 20 to inflate and expand the main body portion 111 of the air bag 110. Straps ST are provided in the main body portion 111 where necessary for retaining the shape of the main body portion 111, so that the main body portion 111 is retained in the predetermined shaped after inflation and expansion thereof. In a similar manner, the pillar portions 112, 112 are also provided with straps ST where necessary. String or separation wall may be used instead of the strap ST. However, if a separation wall extends longitudinally (e.g., in the direction toward the near side or the far side in the drawing) within the main body portion 111, it is preferable to provide a communication hole in the separation wall so as to allow the transmission of the gas through the communication hole.

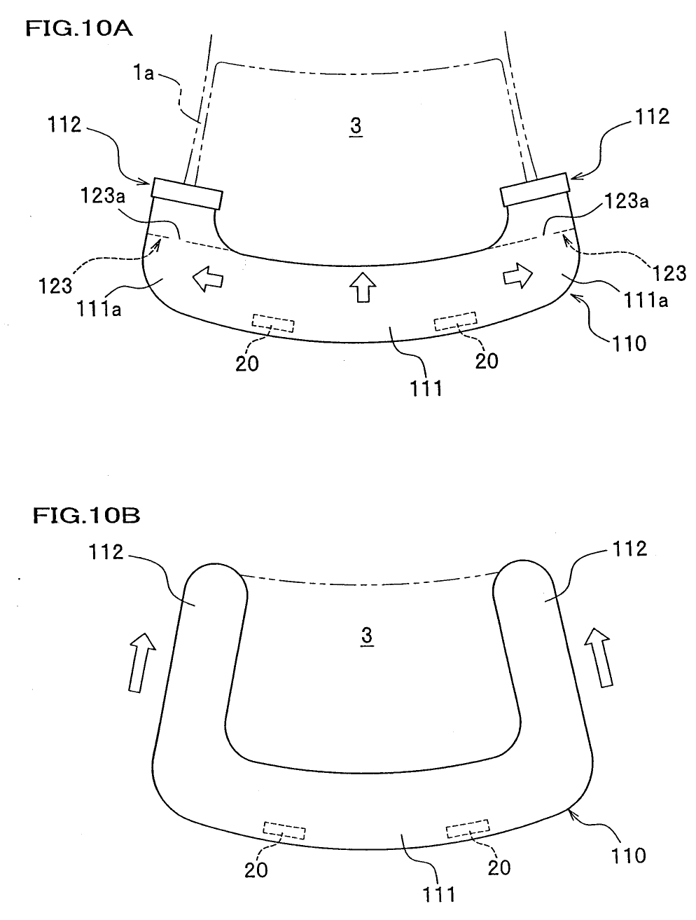

As shown in FIG. 10A, the main body portion 111 inflates and expands along the lower part of the front window glass 3; however, because the sewn part 123 restricts the transmission of the gas from the main body portion 111 to each pillar portion 112, it is possible to restrict expansion of the pillar portion 112 during the expansion of the main body portion 111. In particular, even when the both ends 111a, 111a (FIG. 8E) of the main body portion 111, which have been moved and superposed, expand to restore to the original fully-extended shape, the inflation and expansion of the pillar portions 112, 112 is restricted, thereby preventing flapping motion of each pillar portion 112 due to inflation and expansion of the pillar portions 112, 112 during the expansion of the both ends 111a, 111a of the main body portion 111. When the inflation and expansion of the main body portion 111 is completed, the sewn part 123 is broken or cut off in order from the first sewn part 123A by the expansive force at the both ends 111a, 111a of the main body portion 111 or a predetermined pressure of the gas passing through and widening the gas flow passage 123a. Therefore, the restriction for the transmission of the gas to the pillar portions 112 is gradually released in order from the first sewn part 123A, and as shown in FIG. 10B, the pillar portions 112, 112 then inflate and expand along the front pillars 1a, 1a of the vehicle 1.

According to the collision object protection device 102 as described above, the following advantages are achieved.

Because the sewn part 123 restricts the transmission of the gas to the pillar portions 112 until the inflation and expansion of the main body portion 111 is completed, it is possible to prevent flapping motion of each pillar portions 112 due to expansion of the pillar portions 112,112 in the process of expanding the both ends 111a, 111a of the main body portion 111 that have been moved and superposed and thus to stabilize each pillar portion 112 at a predetermined position.

Because the both ends 111a, 111a of the main body portion 111 are folded up in a bellows fashion in the horizontal direction, the both ends 111a, 111a rapidly expand so that the main body portion 111 is rapidly stabilized as well. Further, the main body portion 111 is rapidly stabilized, so the stiffness of the proximal portion of each pillar portion 112 is ensured. Further, each pillar portion 112 expands in one direction along the front pillar 1a, so flapping motion of each pillar portion 112 is reliably prevented.

Because the transmission of the gas to the pillar potions 112, 112 is readily restricted only by stitching the boundary between the main body portion 111 and each pillar portion 112, it is possible to decrease the manufacturing cost. Further, because the timing at which the gas flows into the pillar portions 112, 112 is readily adjusted only by changing the strength of the thread or the way of stitching, various modifications can be made for the air bag 110 in accordance with types of vehicles or the like.

Because the sewn part 123 is cut off in order from the lower side, namely from the first sewn part 123A, the pillar potions 112, 112 stably inflate and expand along the front pillars 1a, 1a.

Further, the sewn part 123 is provided with the gas flow passage 123a so that a flow of the gas widens the gas flow passage 123a upon inflation and expansion of each pillar portions 112. Therefore, breakage of the sewn part 123 is facilitated and rapid inflation and expansion of each pillar portions 112 is performed.

Because the center part 111b of the main body portion 111 is folded up in a bellows fashion in the vertical direction, even if the width of the center part 111b (length of the main body portion 111 in the vertical direction) is wide, it is possible to rapidly inflate and expand the center part 111b of the main body portion 111.

Further, because each pillar portion 112 is rolled up, the pillar portion 112 inflates and expands at a certain constant rate.

While the present invention has been described with reference to the second embodiment, the present invention is not limited to this specific embodiment.

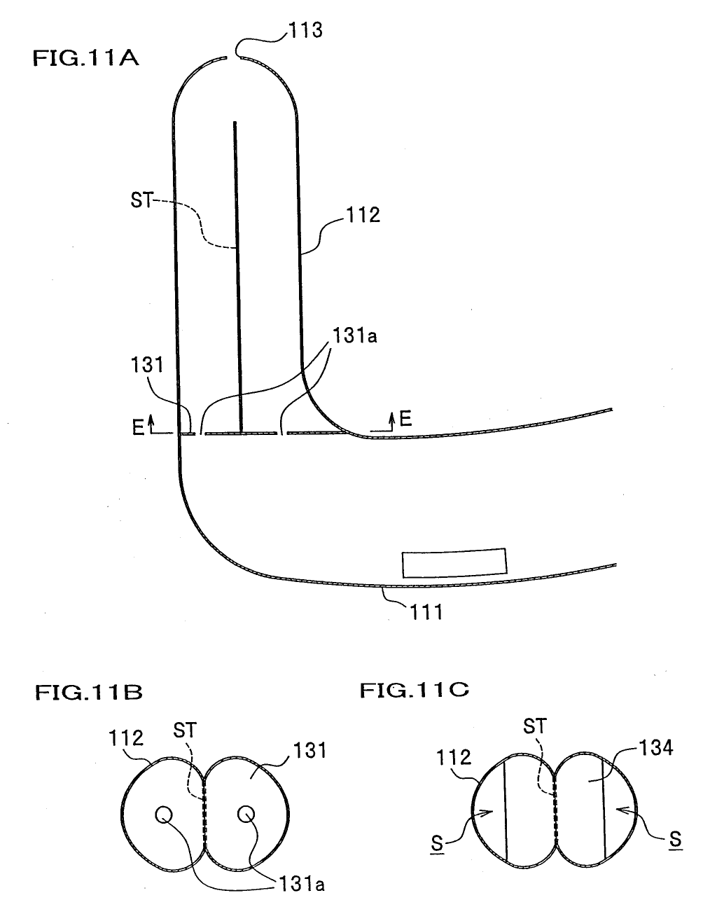

In the above embodiment, the sewn part is used as the restriction. However, the present invention is not limited to this construction and any known parts may be employed as long as they can restrict the transmission of the gas to the pillar portions 112, 112 until the inflation and expansion of the main body portion 111 is completed. For example, as shown in FIG. 11A and 11B, a separation wall 131 having a gas communication hole (gas communication portion) may be provided at the boundary between the main body portion 111 and each pillar portion 112, so that the transmission of the gas to the pillar portions 112, 112 is restricted by this separation wall 131. In this instance, if the inside of the pillar portion 112 is divided into two spaces by a separation wall 133 longitudinally extending within the pillar portion 112, it is preferable to provide a gas communication hole 131a for each space in order to equally supply the gas to each space. Further, instead of providing such a separation wall 131 having the gas communication hole 131a, as shown in FIG. 11C, a separation wall 134 whose width is smaller than the width of the pillar portion 112 in the horizontal direction may be arranged at the center of the pillar portion 112. This separation wall 134 functions to partly restrict the transmission of the gas while allowing through the both gaps S, S formed at both edge portions as the gas communication portions.

The restriction may be formed by fixing the boundary between the main body portion 111 and each pillar portion 112 with glue which can be peeled off at a predetermined pressure. Instead, the boundary may be bound with a string or tape that can be cut off, broken or dropped off at a predetermined pressure. Further, a separation wall with a portion having less fracture strength (breakage promoting portion) such as slit and perforations may be provided at the boundary.

Further, according to the second embodiment, the both ends 111a, 111a of the main body portion 111 are moved to the center and superposed each other. However, these ends 111a, 111a may be folded back to the center. Even in this instance, the inflation and expansion of the pillar portions 112, 112 is prevented during the expansion of the both ends 111a, 111a, and so the flapping motions of the pillar portions 112, 112 can be restricted.

Third Embodiment

Third embodiment of the present invention will be described below with reference to the accompanying drawings. In the drawings, parts similar to those previously described with reference to the first embodiment are denoted by the same reference numerals, and detailed description thereof will be omitted.

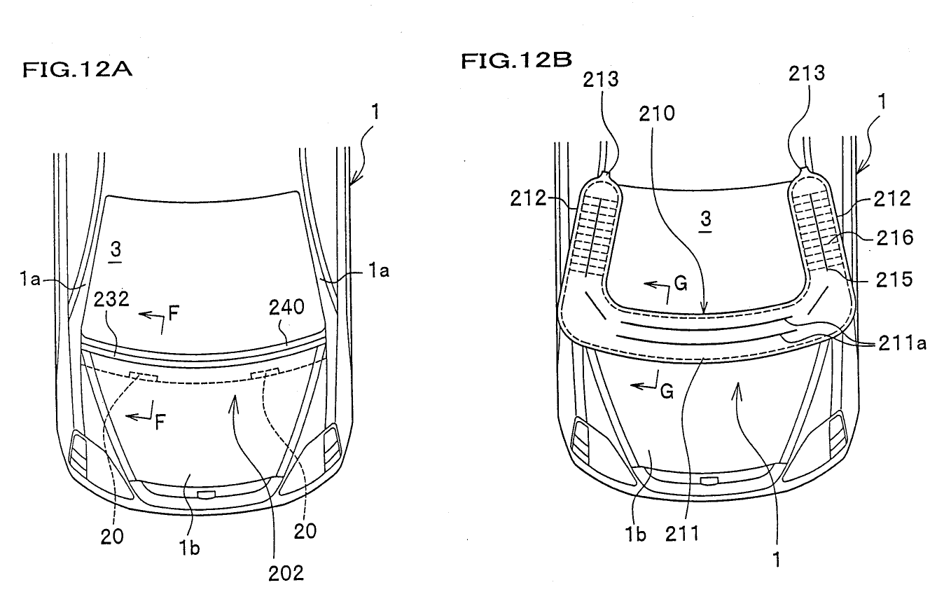

As shown in FIGS. 12A and 12B, a collision object protection device 202 has an air bag 210. The air bag 210 is a tubular bag member, and includes a main body portion 211 which inflates and expands along a lower part of the front window glass 3 of the vehicle 1, and a pair of pillar portions 212, 212 which are bent at both ends of the main body portion 211 and which inflate and expand along the front pillars 1a, 1a of the vehicle 1.

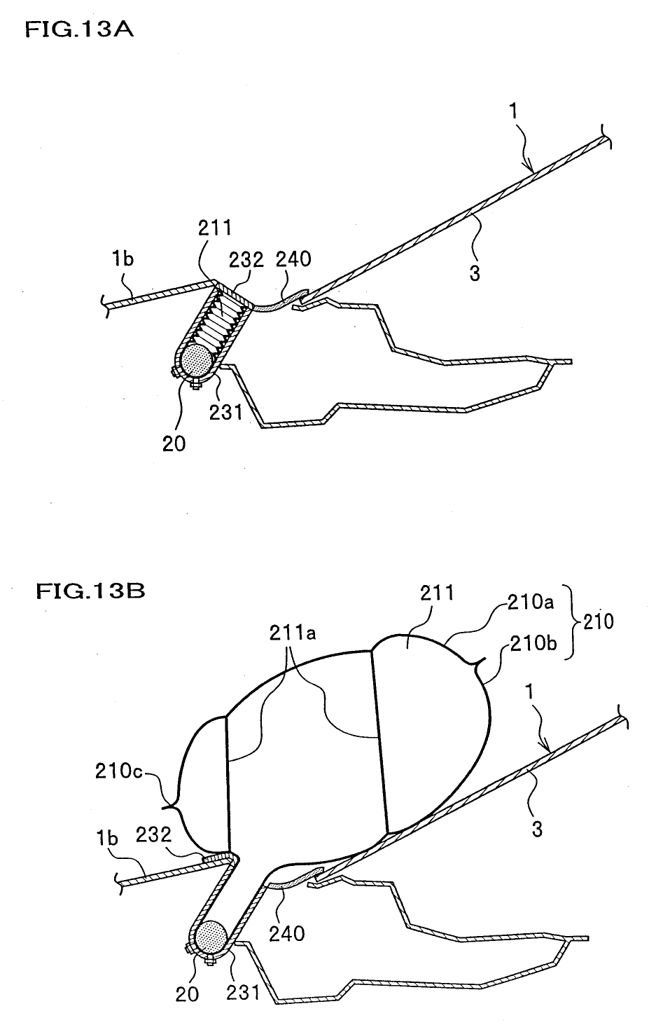

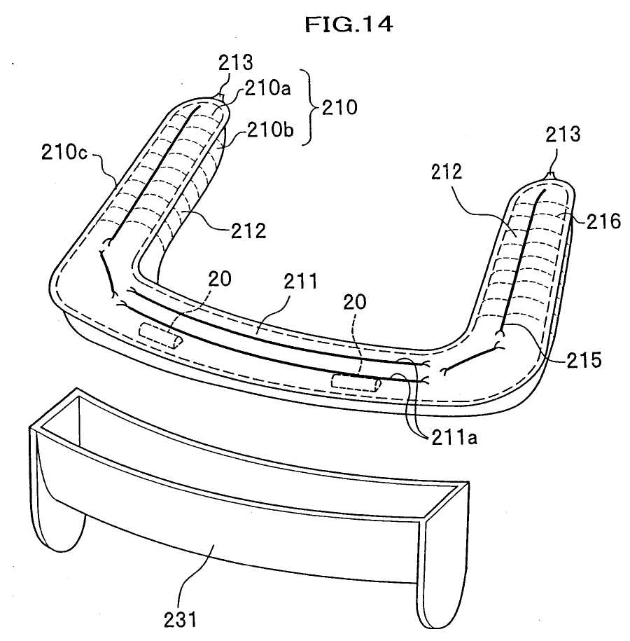

As seen in FIGS. 13B and 14, in order to maintain a proper shape of the air bag 210 upon inflation and expansion and to widely cover the lower part of the front window glass 3 and the front pillars 1a, 1a by the air bag 210, the air bag 210 is provided with tethers 211a, 215 in the main body portion 211 and the pillar portions 212, 212, respectively. The tethers 215, 215 of the pillar portions 212, 212 will be described later.

As seen in FIG. 13A, the air bag 210 is folded and accommodated, before inflation and expansion, in a retainer 231 positioned below the hood 1b of the vehicle 1. The retainer 231 opens in front of the cowl top 240, and the opening of the retainer 231 is covered by a lid member (lid) 232 which forms a continuous surface with the cowl top 240.

According to this embodiment, two inflators 20, 20 are provided at the main body portion 211 as shown in FIG. 12A so that the gas generated by these inflators 20, 20 inflates and expands the air bag 210.

Because the whole air bag 210 can be inflated and expanded by the gas generated by the two inflators 20, 20 each provided at the main body portion 211 without the necessity to provide an inflator 20 respectively at the main body portion 211 and each of the pillar portions 212, 212, the collision object protection device 202 becomes simple in structure.

When the air bag 210 inflates and expands, as illustrated in FIG. 13B, the expansive force makes the lid member 232 open from the opening of the retainer 231 toward the front side of the vehicle 1 so as to inflate and expand the air bag 210 on the vehicle 1.

Pillar portions 212, 212 of the air bag 210 inflate and expand in the vertical direction (see FIG. 12B) along the front pillars 1a, 1a of the vehicle 1. As seen in FIG. 14, each pillar portion 212 is a tubular bag member whose top-side foundation cloth 210a and reverse-side foundation cloth 210b are sewn up at the perimeter 210c to form a tubular bag member.

Because two pillar portions 212, 212 are the same in construction, only one pillar portion 212 positioned on the right hand side as viewed from the front side of the vehicle 1 will be described in the following description, and description to the left-side pillar portion 212 will be omitted.

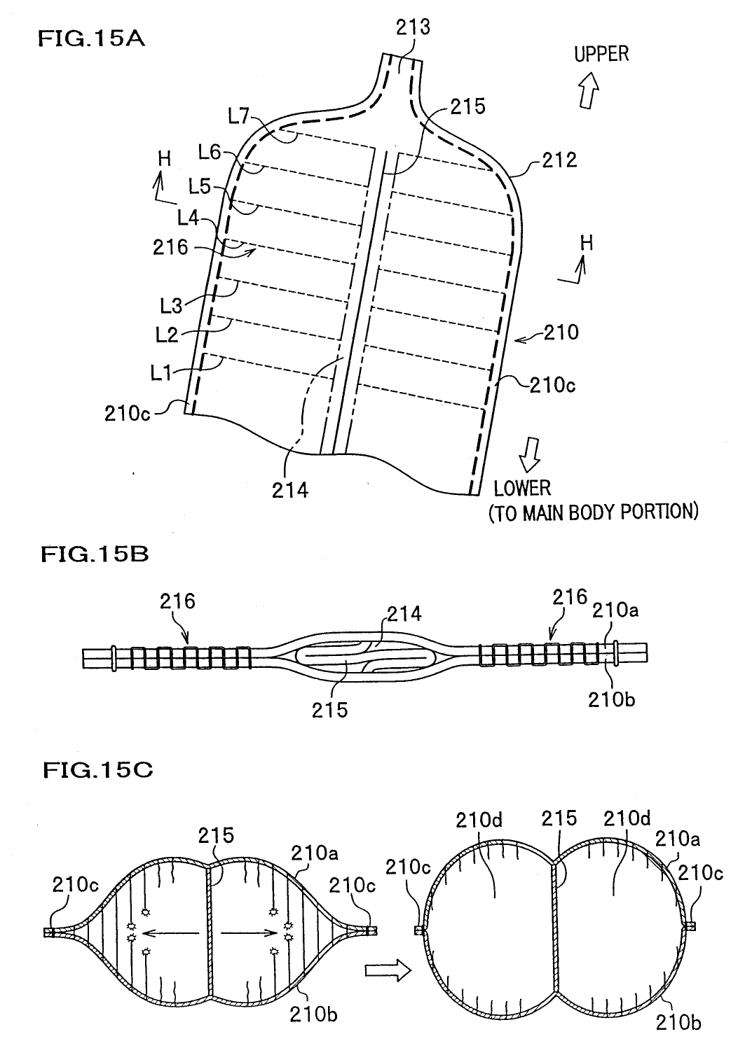

Referring to FIGS. 15A through 15C, upper structure of the pillar portion 212 will be described in detail. In the figures, thickness of the foundation cloth, manner of stitching or the like may be emphasized in accordance with necessity for the purpose of explanation.

As shown in FIG. 15A, the pillar portion 212 includes a vent hole 213 for discharging the gas provided at the distal end (i.e., upper end) of the pillar portion 212, a gas flow passage (discharge passage for the gas) 214 extending from the main body portion 211 toward the vent hole 213, a tether 215 provided in the gas flow passage 214 and maintaining a proper shape of the air bag 210 upon inflation and expansion, and a sewn part 216 as the restriction formed by sewing or stitching the pillar portion 212 in a direction orthogonally intersecting with the gas flow passage 214 without extending across the gas flow passage 214.

As seen in FIG. 15A, the vent hole 213 is a discharge opening for discharging the gas within the air bag 210. The vent hole 213 is formed at the distal end (i.e., upper end) of the pillar portion 212 protruding as a nozzle from the distal end in the upper direction. Gas generated by the inflators 20, 20 (see FIG. 14) flows from the main body portion 211 to each pillar portion 212, and the gas filled in the pillar portion 212 to an elevated internal pressure is then discharged from the vent hole 213 through the gas flow passage 214 which is a non-sewn part and defined by the stitching lines therearound. The vent hole 213 is provided to discharge the gas so that an impact upon contact or collision of the collision object with the air bag 210 can be absorbed.

The gas flow passage 214 is a non-sewn part extending through the sewn part 216 to be described later. The gas flow passage 214 extends in line in the center of the pillar portion 212 from the main body portion 211 to the vent hole 213.

Discharged amount of the gas from the vent hole 213 is properly set, in order to sufficiently absorb an impact upon collision of the collision object with the air bag 210, such that the discharge of the gas is restricted as small amount as possible at an initial stage of the inflation and expansion of the air bag 210 to rapidly expand the air bag 210, that the internal pressure of the air bag 210 is retained in the process of releasing the sewn part 216, and that a predetermined discharged amount of the gas from the vent hole 213 is ensured after the release of the sewn part 216.

According to this embodiment, the gas flow passage 214 is formed to extend from the main body portion 211 to the vent hole 213 penetrating through the sewn part 216, however the gas flow passage 214 is not limited to this arrangement. For example, the sewing thread L7 positioned closely to the vent hole 213 may continuously extend across the gas flow passage 214 to close the gas flow passage 214 so that the sewing thread L7 is cut off upon receipt of a predetermined pressure of the gas and the gas flow passage 214 comes into communication with the vent hole 213.

According to this gas flow passage 214 to be shut off at a first stage, it is possible to inflate and expand the air bag 210 more quickly than the air bag 210 with the gas flow passage 214 penetrating through the sewn part 216.

The gas flow passage 214 extends in line according to the above embodiment. However, the gas flow passage 214 may extend in a meandering manner. Further, a plurality of gas flow passages 214 may be provided.

As best seen in FIG. 15A, the tether 215 is provided inside the gas flow passage 214 to be formed as a non-sewn part, extending in the center part of the pillar portion 212 along the gas flow passage 214 from the main body portion 211 to the vent hole 213, and is formed as a band-like belt member connecting the top-side foundation cloth 210a and the reverse-side foundation cloth 210b.

With this construction of the tether 215, as shown in FIG. 15C, two bag members 210d, 210d having substantially a circular cross section are arranged in the horizontal direction with the tether 215 sandwiched therebetween upon inflation and expansion of the air bag 210, so that the pillar portion 212 widely covers the front pillar 1a of the vehicle 1.

According to the third embodiment, only one tether 215 is provided at the center of the pillar portion 212. However, a plurality of tethers may be provided.

As shown in FIG. 15A, the sewn part 216 is formed by sewing up the top-side foundation cloth 210a and the reverse-side foundation cloth 210b with the sewing threads L1, L2, L3 . . . , and L7. The sewn part 216 is provided to decrease the sectional area of the pillar portion 212 in the form of a tubular bag member and is positioned upstream of the vent hole 213 to restrict a flow of the gas generated by the inflators 20, 20 (see FIG. 14) and flowing from the main body portion 211 to the vent hole 213 of the pillar portion 212.

To be more precise, the sewn part 216 is arranged at right and left sides of the gas flow passage 214 in such a manner as to orthogonally intersect with the gas flow passage 214 without extending across the gas flow passage 214 and to extend from the left-side perimeter 210c of the pillar portion 212 to the left end of the gas flow passage 214 and also from the right end of the gas flow passage 214 to the right-side perimeter 210c of the pillar portion 212.

Therefore, a part of the gas flowing from the main body portion 211 to the vent hole 213 through the gas flow passage 214 is directed to the right and left side perimeters 210c of the pillar portion 212 via the spaces partitioned by each of the adjacent sewing threads L1, L2, L3 . . . , and L7.

As an example of the sewing threads L1, L2, L3 . . . , and L7 for sewing up the top-side foundation cloth 210a and the reverse-side foundation cloth 210b, the size of the sewing thread becomes smaller in turn from the sewing thread L1 to the sewing thread L7 to be readily cut off as the sewing part 216 goes from the main body portion 211 to the vent hole 213.

Namely, during the inflation and expansion of the air bag 210, the volume of the air bag 210 is small and the internal pressure is high at a part close to the main body portion 211 and away from the vent hole 213, that is the part defined by the sewing thread L1, whereas the volume of the air bag 210 becomes larger and the internal pressure becomes smaller as the part defined by the sewing thread shifts closer to the vent hole 213 toward the sewing thread L7. Therefore, by changing the size of the sewing thread such that the sewing thread L7 positioned close to the vent hole 213 is thinner than the sewing thread L1 positioned away from the vent hole 213, it is possible to reliably cut off the sewing threads L1, L2, L3 . . . , and L7.

The collision object protection device 202 as constructed above operates as follows.

As shown in FIG. 12A, when the collision detection device (not shown) detects or predicts a collision with the vehicle 1 based on a signal from the sensor (not shown) or radar (not shown) mounted on the vehicle 1, the collision detection device operates the inflators 20, 20. The air bag 210 is then inflated and expanded on the vehicle 1 as shown in FIG. 12B by the gas generated by the inflators 20, 20.

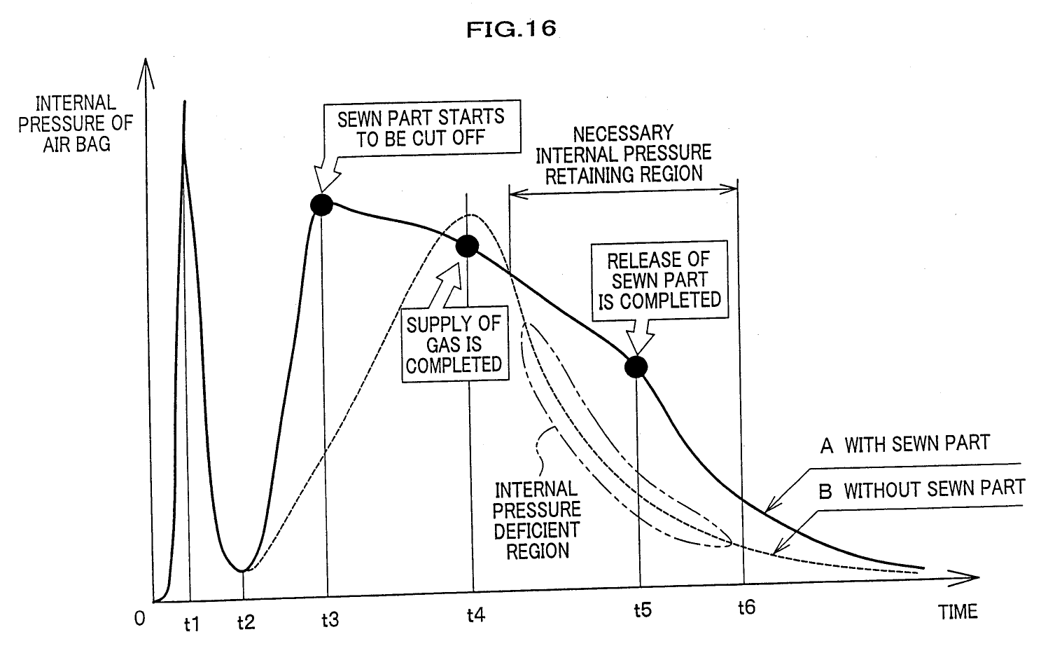

Referring now to FIG. 16, the operation of the air bag 210 upon inflation and expansion will be described in detail. FIG. 16 is a graph showing change of the internal pressure within the air bag 220, in which Line A indicates the collision object protection device with a sewn part according to the third embodiment, and Line B indicates the collision object protection device without a sewn part.

As seen in Line A of FIG. 16, the collision object protection device 202 according to the third embodiment operates the inflators 20, 20 when it detects or predicts a collision. High pressure of gas is then generated and supplied to the air bag 210 which is folded and accommodated in the retainer 231. In this event, the lid member 232 (see FIG. 13A) is released by the pressure for expanding the air bag 210. However, because the air bag 210 has not yet been inflated and expanded, the internal pressure within the air bag 210 instantly increases until the time point t1. Thereafter, the air bag 210 immediately initiates inflation and expansion, and so the internal pressure within the air bag 210 instantly decreases again until the time point t2.

In this state, the air bag 210 has not inflated and expanded sufficiently, and continuously supplying the gas to the air bag 210 allows the internal pressure within the air bag 210 to rapidly increase to the peak point (time point t3). This peak point indicates that the volume of the air bag 210 upon expansion is further increased by filling with the gas and thus is saturated. According to the third embodiment of the present invention, because each pillar portion 212 is provided with the sewn part 216 (see FIG. 15A) so that the volume of the air bag 210 is restricted to the extent of the sewn part 216, the time required to reach the peak point is shortened.

Although a part of the gas flows through the gas flow passage 214 (see FIG. 15A) and is discharged from the vent hole 213, the cross sectional area of the gas flow passage 214 becomes narrow because of the sewn part 216 to thereby create a fluid resistance. Comparing the air bag 210 with the sewn part 216 and the air bag without the sewn part 216, because the sewn part 216 restricts the discharged amount of the gas from the gas flow passage 214, the internal pressure within the air bag 210 increases in a short period of time as shown by the difference between the time points t4-t3.

Providing the gas flow passage 214 makes it possible to expand the pillar portion 212 even before the release of the flow passage with the sewing threads L1, L2, L3 . . . , and L7 of the sewn part 216 being cut off. This is because the gas can be supplied through the gas flow passage 214 as well as through the perimeter 210c of the pillar portion 212 flowing from the gas flow passage 214 via the spaces partitioned by each of the adjacent sewing threads L1, L2, L3 . . . , and L7.

Further, discharging the gas from the vent hole 213 makes it possible to absorb an impact even when the collision object collides with or contact the air bag 210 at an early stage of the expansion of the air bag 210.

Strength of the sewing threads L1, L2, L3 . . . , and L7 of the sewn part 216 is set such that they are cut off or broken when the internal pressure of the air bag 210 reaches to the peak value (time point t3).

To be more specific, as illustrated in FIGS. 15A to 15C, the sewn part 216 breaks in order from the sewing thread L1, which is positioned away from the vent hole 213 and on which the internal pressure of the air bag 210 directly exerts, the sewing thread L2, the sewing thread L3, . . . and to the sewing thread L7. Therefore, as the sewing threads (L1, L2, L3 . . . , and L7) are cut off and the volume of the air bag 210 increases, the internal pressure of the air bag 210 gradually decreases accordingly and finally the supply or injection of the gas from the inflators 20, 20 is completed at the time point t4.

Referring to FIGS. 15A to 15C, description will be further given to the state in which the sewing threads of the sewn part 216 are cut off.

As seen in FIG. 15A, the sewn part 216 extends in a direction orthogonally intersecting with the gas flow passage 214 without extending across the gas flow passage 214. With this arrangement of the sewn part 216, the internal pressure of the air bag 210 exerts on the sewn part 216, and at the same time the tensile force for peeling off the top-side foundation cloth 210a and the reverse-side foundation cloth 210b due to the expanded air bag 210 also exerts on the sewing thread L1 from the gas flow passage 214 as shown in FIG. 15B. Because this tensile force acts in a direction of the stitching lines from the gas flow passage 214 to the perimeter 210c of the pillar portion 212, the sewing threads L1, L2, L3 . . . , and L7 are readily cut off. As shown in FIG. 15C, considering one row of the sewing thread L1, the sewing thread L1 is gradually cut off from the side adjacent to the gas flow passage 214 to the side adjacent to the perimeter 210c to gradually inflate and expand the pillar portion 212.

The sewn part 216 is provided in the pillar portion 212 to a large extent from the sewing thread L1 positioned closely to the main body portion 211 to the sewing thread L7 positioned closely to the vent hole 213. Therefore, the volume of the air bag 210 can be decreased in accordance with the range where the sewn part 216 is provided, and so the air bag 210 can be expanded more quickly in a range extending from the main body portion 211 where the sewn part 216 is not provided (see FIG. 14) to the sewn part 216 of the pillar portion 212.

As described above, because the strength of the sewn part 216 is set such that the sewing threads L1-L7 are gradually and in order cut off with a time lag from the sewing thread L1 to the sewing thread L7, as shown in Line A of FIG. 16, it is possible to extend the time required to entirely release the sewn part 216 (i.e., from the time points t4-t5) to thereby retain the internal pressure necessary for the performance of the air bag 210 for an extended period of time. On the contrary, according to Line B of FIG. 16 indicating the case in which the air bag 210 is not provided with the sewn part 216, there is an area where a shortage of the internal pressure of the air bag 210 occurs between the time points t4-t5.

Once the sewn part 216 is entirely released, the internal pressure of the air bag 210 rapidly decreases. However, because of the time lag as described above, it is possible to ensure the internal pressure of the air bag 210 for the desired period of time (i.e., from time points t4-t5).

The position or the range for providing the sewn part 216, the time required to cut off all the sewing threads L1-L7 to release the sewn part 216 or the like may be arbitrarily determined in consideration of the necessary internal pressure retaining time for the air bag 210 in terms of, for example, the front shape of the vehicle on which the collision object protection device 202 is mounted.

Meanwhile, in the collision object protection device 202 without the sewn part 216 such as shown by Line B of FIG. 16, the internal pressure of the air bag 210 increases more slowly than the air bag 210 with the sewn part 216 until the supply or injection of the gas from the inflators 20, 20 is completed, and then reaches to the peak point (time points t2-t4). This is because in the state of the time point t2, a constant and more than required amount of the gas is always discharged from the vent hole 213, leading to an increased pressure loss.

For this reason, after the supply or injection of the gas from the inflators 20, 20 is completed at the time point t4, the internal pressure of the air bag 210 rapidly decreases. It is therefore necessary to increase the volume of each inflator 20 to compensate the loss of internal pressure (see the internal pressure deficient region).

According to the collision object protection device 202 with the sewn part 216, as previously described, there is a time lag from the time point t3 at which the sewing thread L1 starts to be cut off to the time point t5 at which the sewn part 216 is entirely released, so that the sewn part 216 restricts a flow of the gas and consequently the pressure loss. Therefore, even after the internal pressure of the air bag 210 increases rapidly to the required pressure, it is possible to restrict a decrease in the internal pressure until the restriction is released.

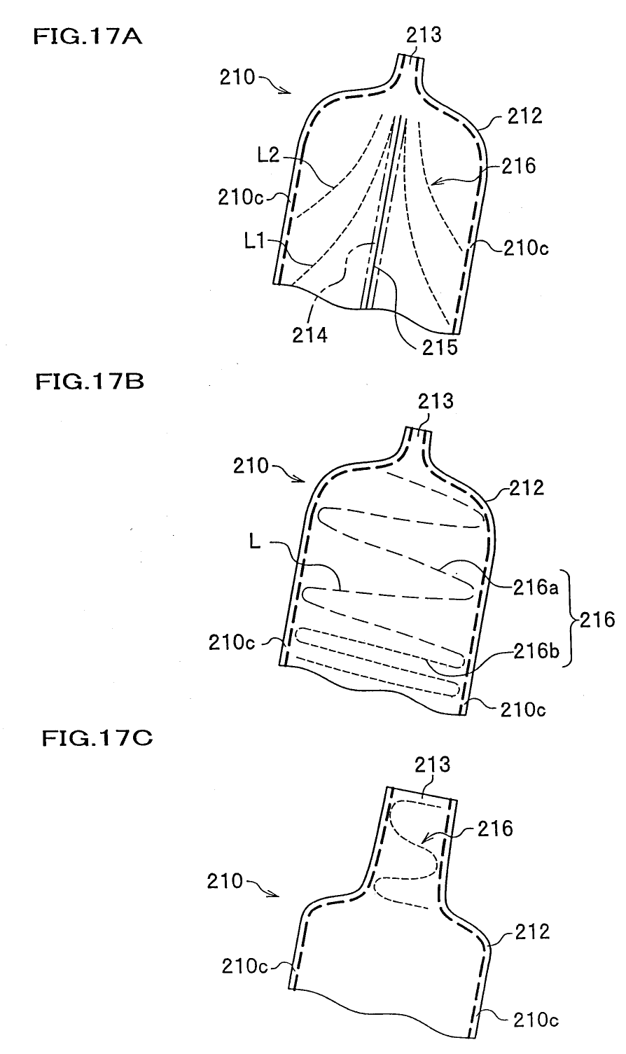

Next, with reference to FIGS. 17A to 17C, modifications of the third embodiment will be described. They are substantially the same in construction as the collision object protection device 202 according to the third embodiment except for the pillar portions. Therefore, description will be given only to the pillar portions and detailed description for other similar parts will be omitted.

According to the first modification as shown in FIG. 17A, the sewn part 216 is provided without extending across the gas flow passage 214. However, in stead of the sewn part 216 extending in the direction orthogonally intersecting with the gas flow passage 214, the sewn part 216 may curve and extend upwardly from the perimeter 210c of the pillar portion 212 toward the vent hole 213.

With this arrangement of the sewn part 216, the internal pressure increased within the air bag 210 converges to the vent hole 213, occurring fluid resistance, restricting a flow pass for the gas, and causing the sewing threads L1, L2 to be cut off in order from the lower side toward the vent hole 213.

According to the second modification as shown in FIG. 17B, in order to adjust the strength of the sewn part 216, instead of adjusting the strength of the sewing thread L according to the third embodiment as above, the sewn part 216 is formed by the combination of different seam pitches and different sewing intervals between adjacent seam lines.

To be more precise, the sewn part 216 is formed by the sewing thread L extending in the width of the pillar portion 212 in a meandering manner. In this sewn part 216, the seam pitch is larger at a part 216a close to the vent hole 213 than at a part 216b away from the vent hole 213, and the sewing interval of adjacent seam lines is larger (i.e., the number of the seam lines is smaller) at the part 216a than at the part 216b.

With this arrangement of the sewn part 216, the sewing thread L is readily cut off at the part 216a close to the vent hole 213 where the internal pressure of the air bag 210 is relatively low, while the sewing thread L is not so readily cut off at the part 216b away from the vent hole 213 where the internal pressure of the air bag 210 is relatively high. Therefore, all the sewing thread L is reliably cut off to release the flow pass for the gas and to discharge the gas from the vent hole 213, thereby more reliably absorbing an impact upon collision of the collision object. Further, because the sewing thread L is cut off without failure, the sewn part 216 can be provided over a large extent of the pillar portion 212. This contributes to an extended internal pressure retaining time within the air bag 210.

Further, because the sewn part 216 according to the second modification is not provided with the gas flow passage 214 as with the first modification, discharge of the gas from the vent hole 213 is not permitted until all parts of the sewing thread L are completely cut off. Therefore, the air bag 210 inflates and expands more quickly, and the internal pressure retaining time can be extended further.

If it takes a long time from when the air bag 210 starts to inflate and expand to when the collision object collides with or contacts the air bag 210, discharge of the gas from the vent hole 213 can be advantageously delayed.

According to the third embodiment as shown in FIG. 17C, the width of the pillar portion 212 is narrow at an upper part thereof, and the sewn part 216 is provided in this narrow part.

With this arrangement of the sewn part 216 positioned in the narrow part, the flow pass for the gas can be effectively restricted. Further, because the sewn part 216 is provided in a limited narrow region, the man hour required for manufacturing the sewn part 216 is advantageously decreased.

While the present invention has been described with reference to the third embodiment and its modifications, the present invention is not limited to these embodiment and modifications and various changes may be made within the scope of the claims.

For example, the sewn part 216 is formed as the restriction for decreasing the sectional area of the bag member. However, the top-side foundation cloth 210a and the reverse-side foundation cloth 210b are fastened or engaged by each other using a fastening means such as Velcro fastening tape, buttons, and clips, so that when the pressure of the gas reaches to a predetermined threshold value, the fastening or the engagement between the top-side foundation cloth 210a and the reverse-side foundation cloth 210b is released.

What is claimed is:

1. A vehicle provided with a collision object protection device which inflates and expands an air bag on the vehicle when a collision with the vehicle is detected or predicted, the vehicle comprising:
a front window glass formed by a laminated glass comprising a couple of transparent base materials between which a transparent intermediate film is sandwiched,
wherein the air bag has a pair of pillar portions which inflate and expand along front pillars of the vehicle, and
wherein the intermediate film in the front window glass has a noise insulation property.

2. A vehicle according to claim 1, wherein the air bag has an anchoring member for inflating and expanding each pillar portion at a predetermined position.

3. A vehicle according to claim 1, wherein the intermediate film has toughness so as to absorb an impact of a collision object hit by the front window glass without allowing the collision object to penetrate through the front window glass.

4. A vehicle according to claim 1, wherein the front window glass absorbs an impact more than the air bag does.

5. A vehicle according to claim 1, wherein the air bag has a main body portion which inflates and expands along a lower part of the front window glass, and the pair of pillar portions which inflate and expand from both ends of the main body portion along the front pillars of the vehicle, and wherein a restriction is provided at a boundary between the main body portion and each of the pillar portions such that transmission of a gas from the main body portion to the pillar portion is restricted until inflation and expansion of the main body portion is completed.

6. A vehicle according to claim 5, wherein both ends of the main body portion are folded up in a bellows fashion in a horizontal direction so that the air bag is accommodated in a retainer positioned below the front window glass.

7. A vehicle according to claim 5, wherein the restriction is a sewn part formed by sewing the boundary, and wherein a pressure within the air bag upon completion of the inflation and expansion of the main body portion breaks or cuts off the sewn part so as to release the restriction on the transmission of the gas from the main body portion to the pillar portion.

8. A vehicle according to claim 7, wherein a plurality of the sewn parts are provided in the pillar portion at predetermined space intervals in a direction from a proximal part of the pillar portion which is adjacent to the main body portion to a distal part of the pillar portion which is remote from main body portion, such that the sewn parts are broken or cut off in order in the direction from the proximal part to the distal part.

9. A vehicle according to claim 7, wherein each sewn part has a communication portion which communicates with spaces partitioned by the sewn part.

10. A vehicle according to claim 5, wherein the restriction is a separation wall having a gas communication portion for transmitting the gas.

11. A vehicle according to claim 5, wherein a center part of the main body portion is folded up in a bellows fashion in such a direction that the pillar portions expand.

12. A vehicle according to claim 5, wherein each pillar portion is rolled up from its distal end.

13. A vehicle according to claim 1, wherein the air bag is a tubular bag member comprising a main body portion which inflates and expands along a lower part of the front window glass, and the pair of pillar portions which inflate and expand from both ends of the main body portion along the font pillars of the vehicle, wherein each pillar portion has a vent hole at a distal end of the pillar portion, and a restriction for decreasing a sectional area of the bag member so as to restrict a flow of a gas directing to the vent hole, and wherein the restriction is formed to be released by a pressure of the gas.

14. A vehicle according to claim 13, wherein the restriction has a discharge passage for the gas flowing to the vent hole.

15. A vehicle according to claim 14, further comprising a tether in the discharge passage, wherein the tether adjusts a shape of the air bag upon expansion of the air bag.

16. A vehicle according to claim 13, wherein the restriction is a sewn part formed by sewing the bag member.

17. A vehicle according to claim 16, wherein the sewn part is formed by sewing the bag member with different threads, and a thread for sewing a part close to the vent hole is weaker than a thread for sewing a part away from the vent hole.

18. A vehicle according to claim 16, wherein the sewn part is formed by sewing the bag member with different seam pitches, and a seam pitch is larger at a part close to the vent hole than at a part away from the vent hole.

19. A vehicle according to claim 16, wherein the sewn part is formed by sewing the bag member with different sewing intervals between adjacent seam lines, and a sewing interval of adjacent seam lines is larger at a part close to the vent hole than at a part away from the vent hole.

20. A vehicle according to claim 13, wherein the restriction is formed such that a part close to the vent hole is more easily released than a part away from the vent hole.

21. A vehicle according to claim 13, wherein a distal end of each pillar portion becomes narrow in width, and the restriction is provided in this narrow part.
